(19) United States
(12) Patent Application Publication
(10) Pub. No.: US 2003/0225936 A1
(43) Pub. Date: Dec. 4, 2003

(54) Application program interface to collect alarm/event data

(76) Inventor: Kris R. Felske, Dryden (CA)

Correspondence Address: WEYERHAEUSER COMPANY, INTELLECTUAL PROPERTY DEPT., CH 1J27, P.O. BOX 9777, FEDERAL WAY, WA, 98063, US

(21) Appl. No.: 10/161,343

(22) Filed: May 30, 2002

(51) Int. Cl. G06F 9/00; G06F 9/46

(52) U.S. Cl. 709/328

(57) ABSTRACT

An article of manufacture, method, and system for automatically collecting, formatting, parsing, and transferring data from a distributed control system (DCS) to a diagnosis/analysis program are provided. The article of manufacture embodies an application interface program (API) which, when executed, performs the steps of: automatically collecting, formatting, and parsing process alarms from each DCS node; automatically collecting, formatting, and parsing operator actions from each DCS node using an SQL call; and automatically collecting, formatting, and parsing system monitor messages from each DCS node using an SQL call. The data may be parsed according to the time collection limits between when the API was last run and the current time. In one embodiment, the DCS is Foxboro's I/A DCS®, and the collected data is transferred by FTP for transmission over a network, such as the Internet, to a remote diagnosis/analysis program such as Honeywell's Control Performance Solution™ including Loop Scout™.

### FIELD OF THE INVENTION

The present invention relates generally to computerized methods for collecting and transferring data, and more specifically to an application program interface (API) for automatically collecting, formatting, parsing, and transferring data from a distributed control system (DCS) to a performance diagnosis/analysis program or network.

### BACKGROUND OF THE INVENTION

A distributed control system (DCS) is a type of a process control system (network) that uses dispersed computers (nodes) throughout a manufacturing/process line for control thereof. A DCS is typically capable of collecting various alarm/event data at the dispersed computers. One example of a DCS is Foxboro's I/A DCS® (Intelligent Automation Distributed Control System), which can collect data such as process alarms, operator actions, and system monitor messages recorded at each of the dispersed computer nodes. Process alarms are alarms created by the DCS node reporting upset process conditions, while operator actions are recorded data of input by an operator, and system monitor messages are messages that report the health of each DCS node.

The collected data, to be useful, needs to be analyzed for use in optimizing the manufacturing/process line. One such means is provided by Honeywell's Control Performance Solution™ (Hi-Spec Solutions @sset.MAX® solutions) including Loop Scout™. Loop Scout™ is a performance diagnosis/analysis solution adapted to aid plant productivity and maintenance efficiency by pinpointing those loops with problems, suggesting improvements, and allowing users to prioritize efforts and allocate resources on a facility-wide basis. Remote performance diagnosis/analysis by Loop Scout™ is available via a secure Internet connection.

Currently, a user must manually upload data from Foxboro's I/A DCS® to Honeywell's Control Performance Solution™ to be analyzed. Specifically, Foxboro's I/A DCS® allows a user to only manually view/print/save process alarms through a user interface. Thus, the process alarms data must be manually parsed and transferred to Control Performance Solution™, which typically takes 15 minutes per DCS node plus the user's travel time from one DCS node to another. Further, Foxboro provides a Graphic User Interface™ to only manually retrieve/print/save operator actions from an Informix™ database provided at each DCS node. Thus, again, the operator actions data must be manually transferred to Control Performance Solution™, which typically takes 5 minutes per DCS node. Finally, Foxboro provides another utility to only manually retrieve/view/print/save system monitor messages from an Informix™ database at each DCS node. Thus, again, the system monitor messages data must be manually transferred, which typically takes 10 minutes per DCS node. Accordingly, currently, collection and transfer of these various alarm/event data take approximately 30 minutes in total per DCS node. These alarm/event data are typically required to be transferred to a diagnosis/analysis program or network (e.g., Control Performance Solution™) at least several times (2-5 times) per day.

Several attempts have been made to more efficiently transfer required data from Foxboro's I/A DCS® to Honeywell's Control Performance Solution™. One such attempt was to use Foxboro's pre-built set of application program interface (API) calls (FoxAPI™ calls). These API calls, however, are not reliable in that they cannot retrieve alarm/event data from any Informix™ databases provided in the DCS. Another attempt was made to utilize printer-port-capture software called LogMate™, available from Tips, Inc. The LogMate™ was linked to a serial port of each of the DCS nodes using a terminal server, and each DCS node was configured to send all alarm/event data (not parsed) to the serial port. This option was undesirable, as it would cause excessive network loading.

Therefore, a need exists for means for automatically collecting, formatting, parsing, and transferring various alarm/event data from a DCS, such as Foxboro's I/A DCS®, to a performance diagnosis/analysis solution or network, such as Honeywell's Control Performance Solution™. Preferably, no user action/intervention is required during such a data collection/transfer process.

### SUMMARY OF THE INVENTION

In order to meet the needs described above, the present invention offers a method and an article of manufacture embodying an application program interface (API) which, when executed by a computer, allows a DCS to automatically collect, format, parse, and transfer data therefrom to a diagnosis/analysis program. The API generally performs three steps: (1) automatically collecting, formatting, and parsing process alarms from each DCS node; (2) automatically collecting, formatting, and parsing operator actions from each DCS node using a Standard Query Language (SQL) call; and (3) automatically collecting, formatting, and parsing system monitor messages from each DCS node using an SQL call.

According to one aspect of the present invention, the API further performs the step of transferring the collected, formatted, and parsed process alarms, operator actions, and system monitor messages by FTP (File Transfer Protocol) to a network server for transmission over a network, such as the Internet.

According to another aspect of the present invention, the process alarms, operator actions, and system monitor messages are parsed according to time collection limits that are set between the time that the API was last run and the current time. In this regard, the API is preferably configured to run periodically according to a predefined schedule. Alternatively, the time collection limits may be set by a user.

According to a further aspect of the present invention, the DCS comprises Foxboro's I/A DCS® and the diagnosis/analysis program comprises Honeywell's Control Performance Solution™ including Loop Scout™.

The present invention also offers a system for automatically collecting, formatting, parsing, and transferring data from a DCS to a remote diagnosis/analysis program. The system generally includes three components: (1) a DCS including a plurality of DCS nodes, each DCS node being linked to an API of the present invention as described above; (2) a network over which the collected, formatted, and parsed process alarms, operator actions, and system monitor messages are transferred from the DCS; and (3) a diagnosis/analysis program for receiving the process alarms, operator actions, and system monitor messages from the DCS.

According to the present invention, various alarm/event data such as process alarms, operator actions, and system monitor messages are automatically collected from various DCS nodes, formatted, parsed, and transmitted to a diagnosis/analysis program for further processing and analysis. No user intervention is required during the data collection/transfer process, and the data collection/transfer may be configured to occur periodically according to a predefined schedule. Therefore, the present invention significantly improves the efficiency of a DCS operation, in particular, its collection and transfer of necessary data to a diagnosis/analysis program to optimize the manufacturing/process line under its control.

### BRIEF DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is a diagram illustrating an exemplary hardware environment used to implement an embodiment of the present invention; and

FIG. 2 is a flowchart illustrating the steps performed according to an embodiment of an API of the present invention.

### DETAILED DESCRIPTION OF THE PREFERRED EMBODIMENT

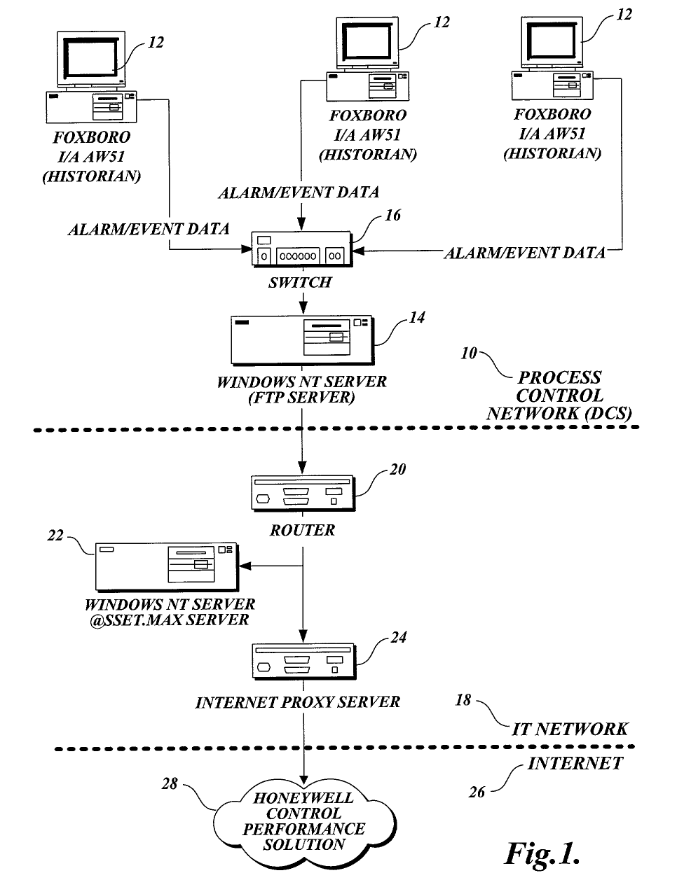

FIG. 1 is a diagram illustrating an exemplary hardware environment used to implement an embodiment of the invention. All hardware components in the diagram, including the configuration of various networks included therein, are well known in the art and thus are not described in detail. A process control network 10 consisting of, for example, Foxboro's I/A DCS®, includes one or more computer nodes 12 at dispersed locations. In the illustrated embodiment, each of the dispersed computer nodes 12 is a Foxboro I/A AW 51™ application workstation including Historian™, which is capable of collecting, processing, and storing various alarm/event data in the form of history files. As illustrated, the computer nodes 12 are all coupled to a network server 14, such as a Windows NT® Server, via one or more switches 16. According to one embodiment, an API of the present invention is resident at, and is executed by, each of the computer nodes 12. The API is configured to automatically collect, format, and parse data such as process alarms, operator actions, and system monitor messages recorded at each of the computer nodes 12, and to transfer the collected, formatted, and parsed data to the network server 14. The network server 14 is an FTP server, and thus, the data from the computer nodes 12 is FTP to the network server 14 for transmission over a network. The API's function essentially ends upon uploading the data to the network server 14.

The data is then to be transmitted to an information technology (IT) network 18, consisting of a router 20, another WindowsNT® server (@sset.MAX® server) 22, and an Internet proxy server 24. In one embodiment, after a Honeywell application called ScoutExpress™ compresses the data (alarm/event files) on the network server 14, the compressed data is transferred via the router 20 to the @sset.MAX® server 22 and then retransmitted via the Internet proxy server 24. The data is then automatically uploaded via the Internet 26 to a remote performance diagnosis/analysis network, such as Honeywell's Control Performance Solution™ including Loop Scout™. Loop Scout™ analyzes the performance of the manufacturing/process line based on the process alarms, operator actions, and system monitor messages data transferred from the process control network 10.

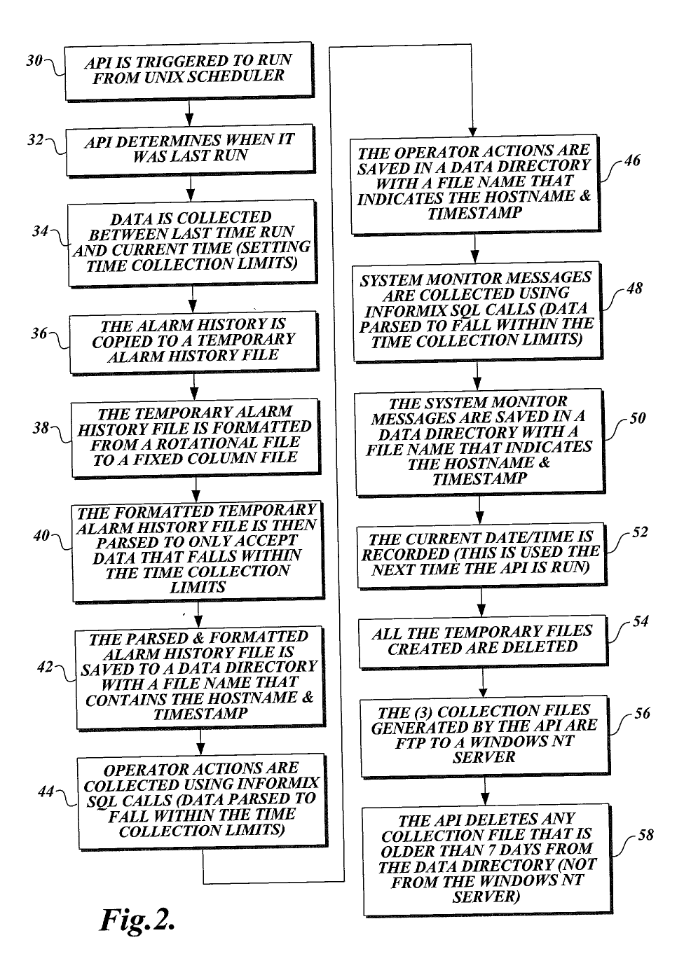

FIG. 2 is a flowchart illustrating the logic performed according to one embodiment of the API of the present invention. In block 30, the API is triggered to run from a scheduler of an operating system. In the illustrated embodiment, the Foxboro I/A DCS® is running on a UNIX™ platform, and a scheduler may be a Unix Crontab Scheduler™. In block 32, the API determines when (i.e., date and time) it was last run. In block 34, time collection limits are set so that data is to be collected between the last time the API was run and the current time. In block 36, an alarm history stored in each Foxboro DCS node, such as Foxboro I/A AW51 (Historian)™ operator/engineering terminal, is copied to a temporary alarm history file. At this time, the entire alarm history from each DCS node (Historian™) is copied, without any time collection limits, which could include up to 80,000 characters (5,000 alarms lines long). In block 38, the temporary alarm history file is formatted from a rotational file (see Table 1 below, for example) to a fixed column file (see Table 2 below, for example). (The sample temporary alarm history includes all process alarms registered since May 11, 18:37:34. Table 2 shows fewer entries than Table 1 due to space limitations.)

TABLE 1
RAW ROTATIONAL ALARM HISTORY DATA (WRAPPED TO FIT WINDOW)

[symbol]

KNOTTER ACCEPTS TANK LEVEL 0HIABS 05-11 18:37:34 47.78% (50.00) LEVEL HIGH RTNBS1_THICK:38LT063
B.S THI 0HIABS 05-11 18:38:54 79.07% (82.00) LEVEL HIGH RTNBS1_SCREEN:38LIC012 KNOTTER ACCEPTS
TANK LEVEL 2HIABS (50.00) LEVEL HIGH ALMBS1_THICK:38LT063 B.S THICKENER LEVEL 1HIABS 05-11
18:39:42 82.79% (82 ALMBS1 SCREEN:38LIC012 KNOTTER ACCEPTS TANK LEVEL 0HIABS 05-11 18:39:55
48.00% (50.00) LEVEL HIGH RTNBL1_ 5% SULPHURIC ACID SYSTEM 0STATE 05-11 18:40:05 Pnt 00
RTNBS1_SCREEN:38L1C012 KNOTTER 2HIABS 05-11 18:40:06 50.39% (50.00) LEVEL HIGH
ALMBS1_THICK:38LT063 B.S THICKENER LEVEL 0HIABS (82.00) LEVEL HIGH RTNBS1_WASH:38FIC115
B.S TO SCREENING FLOW 2LOABS 05-11 18:41:31 −116.84 LPM (4800 ALMBS1_WASH:38FIC115 B.S TO
SCREENING FLOW 1ENABLE 05-11 18:41:31 ALARM MESSAGES ENABLED LOABS BS1_ B.S TO SCREENING FLOW
0LOABS 05-11 18:41:36 5904.03 LPM (4800.00) FLOW LOW RTNBS1_THICK:38LT063 B.S THI 1HTABS 05-11
18:41:54 83.00% (82.00) LEVEL HIGH ALMBS1_THICK:38LIC065 B.S THICKENER SEALTANK LEVEL 2LOABS
(40.00) LEVEL LOW ALMPLC40_1MISC:HD_TK_LVL HD STORAGE TK LEVEL/PLC 5LOABS 05-11 18:42:10 24.99%
(25 ALMBS1_THICK:38L1C065 B.S THICKENER SEALTANK LEVEL 0LOABS 05-11 18:43:08 42.33%
(40.00) LEVEL LOW RTNPLC4 HD STORAGE TK LEVEL/PLC 0LOABS 05-11 18:43:15 25.03% (25.00)
RTNPLC40_1MISC:HD_TK_LVL HD STOR 5LOABS 05-11 18:43:20 24.95% (25.00)
ALMBS1_THICK:38CIT076 4HIABS US/CM (1500.00) CONDUCTIVITY HIGH ALMBS1_THICK:38LT063 B.S
THICKENER LEVEL 0HIABS 05-11 18:45:32 79.40% RTNBS1_SCREEN:38LIC012 KNOTTER ACCEPTS TANK
LEVEL 0HIABS 05-11 18:46:36 47.93% (50.00) LEVEL HIGH RTNPLC4 HD STORAGE TK LEVEL/PLC
0LOABS 05-11 18:47:14 25.03% (25.00) RTNBS1_THICK:38CIT076 0HIABS 05-11 18:58:53 1247.07 US/CM
(1500.00) CONDUCTIVITY HIGH RTNPLC40_1ALARM:PULP_MC_BRK.PULP DE BREA PULP MACH DRY END SHT BRK
1>BRK 2STATE BREAK Pnt 00 ALMBL1_T10:40LIC001 B.S H.D SURGE TANK LEVEL 0LOABS 05-11 19:35:02
22.02% (20.00) LEV RTNBS1_THICK:38LT063 B.S THICKENER LEVEL 1HIABS 05-11 19:55:27 82.07%
(82.00) LEVEL HIGH ALMBS1_ B.S THICKENER LEVEL 0HIABS 05-11 19:59:16 79.85% (82.00) LEVEL
HIGH RTNBL1_CLNR2:40FIC305 SEC. CL 4LOABS 05-11 20:14:59 739.10 LPM (800.00) FLOW LOW
ALMBL1_CLNR2:40FIC305

TABLE 2
FORMATTED ALARM FILE BEFORE DATE PARSING

| | | | | | | | | | |
|---|---|---|---|---|---|---|---|---|---|
| BS1_SCREEN:38LIC012 | KNOTTER ACCEPTS | TANK LEVEL | 0HIABS | 05-11 | 18:37:34 | 47.78% | (50.00) | LEVEL HIGH | RTN |
| BS1_THICK:38LT063 | B.S THICKENER | LEVEL | 0HIABS | 05-11 | 18:38:54 | 79.07% | (82.00) | LEVEL HIGH | RTN |
| BS1_SCREEN:38LIC012 | KNOTTER ACCEPTS | TANK LEVEL | 2HIABS | 05-11 | 18:39:09 | 50.59% | (50.00) | LEVEL HIGH | ALM |
| BS1_THICK:38LT063 | B.S THICKENER | LEVEL | 1HIABS | 05-11 | 18:39:42 | 82.79% | (82.00) | LEVEL HIGH | ALM |
| BS1_SCREEN:38LIC012 | KNOTTER ACCEPTS | TANK LEVEL | 0HIABS | 05-11 | 18:39:55 | 48.00% | (50.00) | LEVEL HIGH | RTN |
| BL1_CHEM:170FAL0066. | | | | | | | | | |

| | | | | | |
|---|---|---|---|---|---|
| SYSTEM STATU | 5% SULPHURIC ACID SYSTEM | 0STATE | 05-11 | 18:40:05 | Pnt 00 PEN |

| BS1_SCREEN:38LIC012 | KNOTTER ACCEPTS | TANK LEVEL | 2HIABS | 05-11 | 18:40:06 | 50.39% | (50.00) | LEVEL HIGH | ALM |
|---|---|---|---|---|---|---|---|---|---|
| BS1_THICK:38LT063 | B.S THICKENER | LEVEL | 0HIABS | 05-11 | 18:40:16 | 77.74% | (82.00) | LEVEL HIGH | RTN |
| BS1_WASH:38FIC115 | B.S TO SCREENING | FLOW | 2LOABS | 05-11 | 18:41:31 −116.84 | | (4800.00) | FLOW LOW | ALM |
| | | | | | LPM | | | | |
| BS1_WASH:38FIC115 | B.S TO SCREENING | FLOW | 1ENABLE | 05-11 | 18:41:31 | ALARM MESSAGES ENABLED LOABS | | | |
| BS1_WASH:38FIC115 | B.S TO SCREENING | FLOW | 0LOABS | 05-11 | 18:41:36 5904.03 | | (4800.00) | FLOW LOW | RTN |
| | | | | | LPM | | | | |
| BS1_THICK:38LT063 | B.S THICKENER | LEVEL | 1HIABS | 05-11 | 18:41:54 | 83.00% | (82.00) | LEVEL HIGH | ALM |
| BS1_THICK:38LIC065 | B.S THICKENER SEALTANK LEVEL | | 2LOABS | 05-11 | 18:41:54 | 39.86% | (40.00) | LEVEL LOW | ALM |
| PLC40_1MISC:HD_TK_{—} | HD STORAGE TK LEVEL/PLC | | 5LOABS | 05-11 | 18:42:10 | 24.99% | (25.00) | | ALM |
| LVL | | | | | | | | | |
| BS1_THICK:38L1C065 | B.S THICKENER SEALTANK LEVEL | | 0LOABS | 05-11 | 18:43:08 | 42.33% | (40.00) | LEVEL LOW | RTN |
| PLC40_1MISC:HD_TK_{—} | HD STORAGE TK LEVEL/PLC | | 0LOABS | 05-11 | 18:43:15 | 25.03% | (25.00) | | RTN |
| LVL | | | | | | | | | |
| PLC40_1MISC:HD_TK_{—} | HD STORAGE TK LEVEL/PLC | | 5LOABS | 05-11 | 18:43:20 | 24.95% | (25.00) | | ALM |
| LVL | | | | | | | | | |
| BS1_THICK:38CIT076 | | | 4HIABS | 05-11 | 18:45:121929.00 | | (1500.00) | CONDUC- | ALM |
| | | | | | US/CM | | | TIVITY | |
| | | | | | | | | HIGH | |
| BS1_THICK:38LT063 | B.S THICKENER | LEVEL | 0HIABS | 05-11 | 18:45:32 | 79.40% | (82.00) | LEVEL HIGH | RTN |
| BS1_SCREEN:38LIC012 | KNOTTER ACCEPTS | TANK LEVEL | 0HIABS | 05-11 | 18:46:36 | 47.93% | (50.00) | LEVEL HIGH | RTN |

| | | | | | | | |
|---|---|---|---|---|---|---|---|
| PLC40_1MISC:HD_TK_{—} | HD STORAGE TK LEVEL/PLC | 0LOABS | 05-11 | 18:47:14 | 25.03% | (25.00) | RTN |
| LVL | | | | | | | |

| | | | | | | |
|---|---|---|---|---|---|---|
| BS1_THICK:38CIT076 | 0HIABS | 05-11 | 18:58:531247.07 | (1500.00) | CONDUC- | RTN |
| | | | US/CM | | TIVITY | |
| | | | | | HIGH | |

In block 40, the formatted temporary alarm history file is then parsed to include only such data as that which falls within the time collection limits set in block 34 above (i.e., from the last time the API was run to the current time). Next, in block 42, the parsed and formatted alarm history file is saved to a data directory with a file name that contains the hostname (i.e., from which DCS node the alarm history is obtained) and timestamp (i.e., the time at which the parsed and formatted alarm history file is saved to the data directory). Table 3 below shows a sample parsed and formatted alarm history file saved to a data directory. In Table 3, the data is parsed to include only the process alarms registered on May 23 between 7:12:36 and 7:44:33, i.e., the last time the API was run and the current time, according to the illustrated embodiment. Although it is preferred that the API does not require any user action during data collection/transfer, the API may be written so as to permit a user intervention to set arbitrary time collection limits, different from the last time the API was run to the current time, if desired.

TABLE 3
ALARM HISTORY FILE AFTER DATE PARSING

| BS1_THICK:38LT063 | B.S THICKENER | LEVEL | 1HIABS | 05-23 | 07:12:36 | 82.06% | (82.00) | LEVEL HIGH | ALM |
|---|---|---|---|---|---|---|---|---|---|
| BS1_WASH:38FIC115 | B.S TO SCREENING | FLOW | 1DISABL | 05-23 | 07:12:43 | ALARM MESSAGES INHIBITED | | | |
| BS1_THICK:38LT063 | B.S THICKENER | LEVEL | 0HIABS | 05-23 | 07:12:54 | 79.98% | (82.00) | LEVEL HIGH | RTN |
| BS1_THICK:38LIC065 | B.S THICKENER SEALTANK LEVEL | | 2LOABS | 05-23 | 07:16:41 | 39.84% | (40.00) | LEVEL LOW | ALM |
| BS1_THICK:38LIC065 | B.S THICKENER SEALTANK LEVEL | | 0LOABS | 05-23 | 07:16:57 | 42.07% | (40.00) | LEVEL LOW | RTN |
| BS1_SCREEN:38LIC012 | KNOTTER ACCEPTS | TANK LEVEL | 2HIABS | 05-23 | 07:26:31 | 50.08% | (50.00) | LEVEL HIGH | ALM |
| BS1_SCREEN:38LIC049 | PRI SCREENS REJ | TANK LEVEL | 2HIABS | 05-23 | 07:27:09 | 65.14% | (65.00) | LEVEL HIGH | ALM |
| BS1_SCREEN:38LIC050 | SEC SCREENS REJ | TANK LEVEL | 2HIABS | 05-23 | 07:36:40 | 65.02% | (65.00) | LEVEL HIGH | ALM |
| BS1_THICK:38LT063 | B.S THICKENER | LEVEL | 1HIABS | 05-23 | 07:37:06 | 82.44% | (82.00) | LEVEL HIGH | ALM |
| BS1_THICK:38LT063 | B.S THICKENER | LEVEL | 0HIABS | 05-23 | 07:37:36 | 78.27% | (82.00) | LEVEL HIGH | RTN |
| BS1_SCREEN:38LIC012 | KNOTTER ACCEPTS | TANK LEVEL | 0HIABS | 05-23 | 07:38:06 | 47.40% | (50.00) | LEVEL HIGH | RTN |
| BS1_THICK:38LIC065 | B.S THICKENER SEALTANK LEVEL | | 2HIABS | 05-23 | 07:38:15 | 90.53% | (90.00) | LEVEL HIGH | ALM |
| BS1_THICK:38LIC065 | B.S THICKENER SEALTANK LEVEL | | 0HIABS | 05-23 | 07:41:51 | 87.97% | (90.00) | LEVEL HIGH | RTN |
| BS1_WASH:38FIC115 | B.S TO SCREENING | FLOW | 2LOABS | 05-23 | 07:41:52 396.16 | | (4800.00) | FLOW LOW | ALM |
| | | | | | LPM | | | | |
| BS1_WASH:38FIC115 | B.S TO SCREENING | FLOW | 1ENABLE | 05-23 | 07:41:52 | ALARM MESSAGES ENABLED LOABS | | | |
| BS1_WASH:38FIC115 | B.S TO SCREENING | FLOW | 0LOABS | 05-23 | 07:42:02 5570.44 | | (4800.00) | FLOW LOW | RTN |
| | | | | | LPM | | | | |
| BS1_WASH:38FIC115 | B.S TO SCREENING | FLOW | 2LOABS | 05-23 | 07:42:48 4593.18 | | (4800.00) | FLOW LOW | ALM |
| | | | | | LPM | | | | |
| BS1_WASH:38FIC115 | B.S TO SCREENING FLOW | | 1DISABL | 05-23 | 07:42:51 | ALARM MESSAGES INHIBITED LOABS | | | |
| BS1_THICK:38LIC065 | B.S THICKENER SEALTANK LEVEL | | 2HIABS | 05-23 | 07:42:58 | 90.36% | (90.00) | LEVEL HIGH | ALM |
| BS1_THICK:38LT063 | B.S THICKENER | LEVEL | 1HIABS | 05-23 | 07:43:14 | 84.05% | (82.00) | LEVEL HIGH | ALM |
| BS1_THICK:38LIC065 | B.S THICKENER SEALTANK LEVEL | | 0HIABS | 05-23 | 07:43:20 | 87.84% | (90.00) | LEVEL HIGH | RTN |
| BS1_THICK:38LT063 | B.S THICKENER | LEVEL | 0HIABS | 05-23 | 07:43:32 | 76.66% | (82.00) | LEVEL HIGH | RTN |

| | | | | | | | | |
|---|---|---|---|---|---|---|---|---|
| BS1_THICK:38LIC065 | B.S THICKENER SEALTANK LEVEL | 2HIABS | 05-23 | 07:43:37 | 90.04% | (90.00) | LEVEL HIGH | ALM |

| | | | | | | | | |
|---|---|---|---|---|---|---|---|---|
| BS1_WASH:38FIC115 | B.S TO SCREENING | FLOW | 2LOABS | 05-23 | 07:44:33 34.93 | (4800.00) | FLOW LOW | ALM |
| | | | | | LPM | | | |

| | | | | | | |
|---|---|---|---|---|---|---|
| BS1_WASH:38FIC115 | B.S TO SCREENING | FLOW | 1ENABLE | 05-23 | 07:44:33 | ALARM MESSAGES ENABLED LOABS |

In block 44, operator actions are collected using Informix™ SQL calls. As briefly discussed above, the operator actions are stored in a Foxboro Historian™, which is in accordance with an Informix™ relational database management system and thus can be readily accessed using the American National Standards Institute (ANSI) SQL. In block 44, the data is also parsed to include only the operator actions that fall within the time collection limits set in block 34 above. In block 46, the parsed operator actions are saved in a data directory with a file name that contains the hostname and timestamp. Table 4 below shows a sample operator actions file saved to a data directory.

TABLE 4
FORMATTED OPERATOR ACTIONS

INFORMIX-SQL Version 4.20.Ucl
Copyright (C) Informix Software, Inc., 1984-1996

| | | | | | | | |
|---|---|---|---|---|---|---|---|
| 2002-05-23 | 07:11:16 | 40DMO5 | SCNPLC40 | N10_2 | IN_8 | Reset | to Set |
| 2002-05-23 | 07:11:21 | 40DMO5 | SCNPLC40 | N10_2 | IN_8 | Set | to Reset |
| 2002-05-23 | 07:11:22 | 40DMO5 | BS1_SCREEN2 | 38FIC088 | MA | Manual | to Auto |
| 2002-05-23 | 07:11:28 | 40DMO5 | BS1_SCREEN2 | 38PIC035 | OUT | 0.0000 | to 85.00 |
| 2002-05-23 | 07:11:33 | 40DMO5 | BS1_SCREEN | 38FIC037 | OUT | 0.0000 | to 50.00 |
| 2002-05-23 | 07:11:35 | 40DMO5 | BS1_SCREEN | 38FIC037 | MA | Manual | to Auto |
| 2002-05-23 | 07:11:47 | 40DMO5 | BS1_SCREEN2 | 38PIC035 | OUT | 85.00 | to 90.00 |
| 2002-05-23 | 07:11:59 | 40DMO5 | BS1_SCREEN2 | 38FIC088 | MA | Auto | to Manual |
| 2002-05-23 | 07:12:04 | 40DMO5 | BS1_SCREEN2 | 38FIC088 | OUT | 5.3524 | to 50.00 |
| 2002-05-23 | 07:12:05 | 40DMO5 | BS1_SCREEN2 | 38FIC088 | MA | Manual | to Auto |
| 2002-05-23 | 07:12:31 | 40DMO5 | BS1_SCREEN2 | 38PIC030 | OUT | 85.00 | to 0.0000 |
| 2002-05-23 | 07:12:41 | 40WP05 | SCNPLC40 | N10_0 | IN_5 | Set | to Reset |
| 2002-05-23 | 07:12:46 | 40WP05 | SCNPLC40 | N10_0 | IN_5 | Reset | to Set |
| 2002-05-23 | 07:12:51 | 40WP05 | SCNPLC40 | N10_0 | IN_10 | Reset | to Set |
| 2002-05-23 | 07:12:56 | 40WP05 | SCNPLC40 | N10_0 | IN_10 | Set | to Reset |
| 2002-05-23 | 07:12:58 | 40WP05 | BS1 SCREEN | 38PIC013 | OUT | 80.00 | to 75.00 |
| 2002-05-23 | 07:13:00 | 40WP05 | BS1_SCREEN | 38PIC013 | OUT | 75.00 | to 70.00 |
| 2002-05-23 | 07:13:01 | 40WP05 | BS1_SCREEN | 38PIC013 | OUT | 70.00 | to 65.00 |
| 2002-05-23 | 07:13:05 | 40WP05 | BS1_SCREEN | 38PIC013 | OUT | 65.00 | to 60.00 |
| 2002-05-23 | 07:13:22 | 40DM05 | BS1_THICK | 38SIC053 | MA | Auto | to Manual |
| 2002-05-23 | 07:13:22 | 40DM05 | BS1_THICK | 38SIC053 | LR | Remote | to Local |

In block 48, system monitor messages are collected also by using Informix SQL calls. Again, the data is parsed to include only the system monitor messages that fall within the time collection limits set in block 34 above. In block 50, the parsed system monitor messages are saved in a data directory with a file name that contains the hostname and timestamp. Table 5 below shows a sample system monitor messages file saved to a data directory.

TABLE 5
FORMATTED SYSTEM MESSAGES

INFORMIX-SQL Version 4.20.UCl
Copyright (C) Informix Software, Inc., 1984-1996

| | | | | | |
|---|---|---|---|---|---|
| 2002-05-23 | 08:16:15 | SYSMON = MON331 | CP3312 | Fault Tolerant Exec | SM_MSG -00047 Fault Tolerant Prim Module Now Single. |
| | | | | | ROM Addr 00006C074427 |
| 2002-05-23 | 08:16:15 | SYSMON = MON331 | CP3312 | Error Protocol | FTXSS 000090 Modules failed to sync up prior to mem to mem |
| | | | | | 00006C074430 |
| 2002-05-23 | 08:16:16 | SYSMON = MON331 | CP3312 | Error Protocol | FTXSS 000090 Modules failed to sync up prior to mem to mem |
| | | | | | 00006C074430 |
| 2002-05-23 | 08:17:36 | SYSMON = MON331 | CP3312 | Software Manager | SYSMON -00003 Powerup reboot OK. ROM Addr = 00006C074430 |
| 2002-05-23 | 08:17:39 | SYSMON = MON331 | CP3312 | Fault Tolerant Exec | SM_MSG -00046 Fault Tolerant Modules Now Married |
| 2002-05-23 | 11:28:09 | SYSMON = MON331 | CP3312 | Station | SYSMON -00045 Equipment failure acknowledged |
| 2002-05-23 | 23:39:03 | SYSMON = MON331 | CP3312 | Fault Tolerant Exec | SM MSG -00047 Fault Tolerant Prim Module Now Single. |
| | | | | | ROM Addr 00006C074427 |
| 2002-05-23 | 23:39:04 | SYSMON = MON331 | CP3312 | Error Protocol | FTXSS 000090 Modules failed to sync up prior to mem to mem |
| | | | | | 00006C074430 |
| 2002-05-23 | 23:39:04 | SYSMON = MON331 | CP3312 | Error Protocol | FTXSS 000090 Modules failed to sync up prior to mem to mem |
| | | | | | 00006C074430 |
| 2002-05-23 | 23:40:24 | SYSMON = MON331 | CP3312 | Software Manager | SYSMON -00003 Powerup reboot ON. ROM Addr = 00006C074430 |
| 2002-05-23 | 23:40:29 | SYSMON = MON331 | CP3312 | Fault Tolerant Exec | SM MSG -00046 Fault Tolerant Modules Now Married |

In block 52, the current date and time are recorded, to be used the next time the API is run. (See block 32 above.) In block 54, all the temporary files created are deleted. In block 56, the three collection files generated and saved by the API containing parsed process alarms, operator actions, and system monitor messages, respectively, are FTP to a WindowsNT® server (14 in FIG. 1). Finally, in block 58, the API deletes any collection file that is older than a predetermined time period, for example 7 days, from the corresponding data directory. Preferably, though, all the collection files are not deleted from the WindowsNT® server 14 to be archived.

Accordingly, an API of the present invention provides a convenient way of automatically collecting, formatting, parsing, and transferring various alarm/event data including process alarms, operator actions, and system monitor messages from a DCS to a performance diagnosis/analysis program or network.

### EXAMPLE

The following lists four sets of sample code adapted for automatically collecting, formatting, parsing, and transferring data from Foxboro's I/A DCS® to Honeywell's Control Performance Solution™ including Loop Scout™. The first set of code, Setup File (setup_pas), converts three temporary directory files for storing process alarms (pas_collect.tmp), operator actions (oaj.tmp), and system monitor messages (sys.tmp), respectively, to permanent directory files. The second set of code, Operator Action SQL Call (oaj.ace), is an SQL call for collecting, parsing, and formatting operator actions from each DCS node. The third set of code, System Monitor Message SQL Call (sys.ace), is another SQL call for collecting, parsing, and formatting system monitor messages from each DCS node. Finally, the fourth set of code, Main Data Collector Code (pas_collect), embodies an API for performing the steps illustrated in the flowchart of FIG. 1. Basic UNIX™ operating system commands are used in the API of the present embodiment to format and parse data in an alarm history file. Also, the API embodied in Main Data Collector Code (pas_collect) utilizes the permanent directory files created by Setup File (setup_pas) and includes calls to Operator Action SQL Call (oaj.ace) and System Monitor Message SQL Call (sys.ace).

Setup File (setup_pas)

#!/bin/sh
#

| | |
|---|---|
| # | File Name: setup_pas |

#
INFORMIXDIR=/opt/informix
DBPATH=/opt/informix/bin
HOMEDIR=′pwd′
export INFORMIXDIR DBPATH HOMEDIR
#
aplbug=′cat /etc/aplbug′
hist=′cat /etc/histlocs | grep $aplbug | cut -c1-6′
#
mkdir $HOMEDIR/data
set -e ′ s#HOMEDIRSETUP# ′ $HOMEDIR ′ # ′ -e ′ s/APLBUG/ ′ $aplbug ′ / ′
$HOMEDIR/pas_collect.tmp > $HOMEDIR/pas_collect
sed -e ′s/historian/′$hist′/′ -e ′s/APLBUG/′$aplbug′/′ $HOMEDIR/oaj.tmp > $HOMEDIR/oaj.ace
sed -e ′s/historian/′$hist′/′ -e ′s/APLBUG/′$aplbug′/′ $HOMEDIR/sys.tmp > $HOMEDIR/sys.ace
$DBPATH/saceprep $HOMEDIR/oaj
$DBPATH/saceprep $HOMEDIR/sys
chmod 777 $HOMEDIR/pas_collect
#
echo ′″01-01 00:00:00″ ALM′ > $HOMEDIR/pas_collect.dat
echo ′″2002-01-01 00:00:00″ OAJ′ >> $HOMEDIR/pas_collect.dat
#
rm $HOMEDIR/oaj.tmp $HOMEDIR/sys.tmp $HOMEDIR/pas_collect.tmp
#
echo ″Setup Complete″

Operator Action SQL Call (oaj.ace)

{

File Name: oaj.ace
Created for APLBUG

}
database

historian

end
define

| | |
|---|---|
| param[1] area char(20) | {Workstation LBUG} |
| param[2] start char(20) | {Start Time yyyy-mm-dd} |
| param[3] finish char(20) | {Finish Time yyyy-mm-dd} |

end
output

page length 15000

end
select *

from operation
where

| | |
|---|---|
| time_tag[1,20] >= $start | {time-tag is yyyy-mm-dd hh:mm:ss} |

| | |
|---|---|
| and time_tag[1,20] <= $finish | {time_tag is yyyy-mm-dd hh:mm:ss} |
| and station LIKE $area | |

| | |
|---|---|
| order by time_tag | {sort result} |

end
format

on every row

print time_tag, station, compound, block, parm, description

end

System Monitor Message SQL Call (sys.ace)

{

File Name: sys.ace
Created for APLBUG

}
database

historian

end
define

| | |
|---|---|
| param[1] start char(20) | {Start Time yyyy-mm-dd HH:MM:SS} |
| param[2] finish char(20) | {Finish Time yyyy-mm-dd HH:MM:SS} |

end
output

page length 15000

end
select *

from sysmonmsg
where

| | |
|---|---|
| time_tag[1,20) >= $start | {time_tag is yyyy-mm-dd hh:mm:ss} |

| | |
|---|---|
| and time_tag[1,20] <= $finish | {time_tag is yyyy-mm-dd hh:mm:ss} |

| | |
|---|---|
| order by time_tag | {Sort result} |

end
format

on every row

print time_tag, msg_name, smon_name, station, src_name, text

end

Main Data Collector Code (pas_collect)

#!/bin/sh
#

| | |
|---|---|
| # | File Name: pas_collect |
| # | |
| # | Created for APLBUG |
| # | |
| # | |

INFORMIXDIR=/opt/informix
DBPATH=/opt/informix/bin
HOMEDIR=HOMEDIRSETUP
export INFORMIXDIR DBPATH HOMEDIR
#
station=′APLBUG′
stamp=′date ′+%y%m%d%H%M%S′′

| | |
|---|---|
| username=′USER′ | # Change USER to Honeywell LoopScout username |

| | |
|---|---|
| ftp_serv=′hostftp′ | # Change to FTP Server name in /etc/hosts |
| nt_dir=′/pas′ | # Change to directory name on FTP Server |

last_OAJ=′cat $HOMEDIR/pas_collect.dat | grep OAJ | cut -c0-21′
last_ALM=′cat $HOMEDIR/pas_collect.dat | grep ALM | cut -c0-16′
current_OAJ= ′″′′date ′+20%y-%m-%d %H:%M:$S′′′″′
current_ALM= ′″′′date ′+%m-%d %H:%M:%S′′′″′
echo ″Data collection from $last_OAJ to $current_OAJ″
#
# Copy alarm history file to a temp almhist.tmp file
#
cp /usr/hstorian/almhist $HOMEDIR/almhist.tmp
#
# Format almhist file from rotational to readable
#
cut -c161-800160 $HOMEDIR/almhist.tmp | fold -160 > $HOMEDIR/alarms.tmp
echo ″awk ′substr(\$0,81,14) > $last_ALM && substr(\$0,81,14) < $current_ALM {print $0}′
$HOMEDIR/alarms.tmp″ > $HOMEDIR/script.tmp
chmod 777 $HOMEDIR/script.tmp
$HOMEDIR/script.tmp > $HOMEDIR/data/″$username″_″$station″_″$stamp″_0.fox
#
# Gather OAJ information from Informix SQL database and format data
#
echo ″$DBPATH/sacego $HOMEDIR/oaj.ace % $last_OAJ $current_OAJ″ > $HOMEDIR/script.tmp
chmod 777 $HOMEDIR/script.tmp
$HOMEDIR/script.tmp > $HOMEDIR/data/″$username″_″$station″_″$stamp″_2.fox
#
# Gather SYSMONMSG information from Informix SQL database and format data
#
echo ″$DBPATH/sacego $HOMEDIR/sys.ace $last_OAJ $current_OAJ″ > $HOMEDIR/script.tmp
chmod 777 $HOMEDIR/script.tmp
$HOMEDIR/script.tmp > $HOMEDIR/data/″$username″_″$station″_″$stamp″_4.fox
#
# Remove all tmp files created
#
rm $HOMEDIR/almhist.tmp $HOMEDIR/alarms.tmp $HOMEDIR/script.tmp
#
# Modify fox_collect.dat file to indicate last time data collected
#
echo ″Scurrent_ALM\tALM″ > $HOMEDIR/pas_collect.dat
echo ″$current_OAJ\tOAJ″ >> $HOMEDIR/pas_collect.dat
#
# FTP data files from AW/AP to Windows NT
#
ftp ″$ftp_serv″ <<!EOF
prompt
cd ″$nt_dir″
lcd ″$HOMEDIR″/data
mput ″$username″_″$station″_″$stamp″*
bye
!EOF
# Remove any data files older than 7 days
#
find $HOMEDIR/data/ -mtime +7 -exec rm { } \;
#
echo ″Operation Finished″
#

While the preferred embodiments of the invention have been illustrated and described, it will be appreciated that various changes can be made therein without departing from the spirit and scope of the invention. For example, other types and configurations of computers, computer programs, and networks may be used, as will be apparent to those skilled in the art.

The embodiments of the invention in which an exclusive property or privilege is claimed are defined as follows:

1. An article of manufacture embodying an application program interface (API) that is executed by a computer, wherein the API allows a distributed control system (DCS) to collect and transfer data therefrom to a diagnosis/analysis program by performing the steps of:
automatically collecting, formatting, and parsing process alarms from each DCS node;
automatically collecting, formatting, and parsing operator actions from each DCS node using an SQL call; and
automatically collecting, formatting, and parsing system monitor messages from each DCS node using an SQL call.

2. The article of claim 1, wherein the API further performs the step of transferring the collected and parsed process alarms, operator actions, and system monitor messages by FTP for transmission over a network.

3. The article of claim 1, wherein the process alarms, operator actions, and system monitor messages are parsed according to time collection limits that are set between the time that the API was last run and the current time.

4. The article of claim 1, wherein the process alarms, operator actions, and system monitor messages are parsed according to time collection limits that are set by a user.

5. The article of claim 1, wherein the DCS comprises Foxboro's I/A DCS.

6. The article of claim 1, wherein the diagnosis/analysis program comprises Honeywell's Control Performance Solution.

7. The article of claim 1, wherein the API is configured to run periodically according to a predefined schedule.

8. A method for automatically collecting and transferring data from a distributed control system (DCS) to a diagnosis/analysis program, comprising the steps of:
automatically collecting, formatting, and parsing process alarms from each DCS node;
automatically collecting, formatting, and parsing operator actions from each DCS node using an SQL call; and
automatically collecting, formatting, and parsing system monitor messages from each DCS node using an SQL call.

9. The method of claim 8, further performing the step of transferring the collected and parsed process alarms, operator actions, and system monitor messages by FTP for transmission over a network.

10. The method of claim 8, wherein the process alarms, operator actions, and system monitor messages are parsed according to time collection limits that are set between the time that the last data collection occurred and the current time.

11. The method of claim 8, wherein the process alarms, operator actions, and system monitor messages are parsed according to time collection limits that are set by a user.

12. The method of claim 8, wherein the DCS comprises Foxboro's I/A DCS.

13. The method of claim 8, wherein the diagnosis/analysis program comprises Honeywell's Control Performance Solution.

14. A system for automatically collecting and transferring data from a distributed control system (DCS) to a remote diagnosis/analysis program, comprising:
(a) a DCS including a plurality of DCS nodes, each DCS node being linked to an application program interface (API) that is executed by the DCS node, wherein the API performs the steps of:
(i) automatically collecting, formatting, and parsing process alarms from each DCS node;
(ii) automatically collecting, formatting, and parsing operator actions from each DCS node using an SQL call; and
(iii) automatically collecting, formatting, and parsing system monitor messages from each node using an SQL call;
(b) a network over which the collected and parsed process alarms, operator actions, and system monitor messages are transferred from the DCS; and
(c) a diagnosis/analysis program for receiving the process alarms, operator actions, and system monitor messages from the DCS.

15. The system of claim 14, wherein the process alarms, operator actions, and system monitor messages are parsed according to time collection limits that are set between the time that the API was last run and the current time.

16. The system of claim 14, wherein the process alarms, operator actions, and system monitor messages are parsed according to time collection limits that are set by a user.

17. The system of claim 14, wherein the DCS comprises Foxboro's I/A DCS.

18. The system of claim 14, wherein the network comprises the Internet.

19. The system of claim 14, wherein the diagnosis/analysis program comprises Honeywell's Control Performance Solution.

20. The system of claim 14, wherein the API is configured to run periodically according to a predefined schedule.
